(19) United States
(12) Patent Application Publication
(10) Pub. No.: US 2006/0183956 A1
(43) Pub. Date: Aug. 17, 2006

(54) Method of transporting waste explosive materials

(75) Inventor: Harley Heaton, Manassas, VA (US)

Correspondence Address: NIXON & VANDERHYE, PC, 901 NORTH GLEBE ROAD, 11TH FLOOR, ARLINGTON, VA, 22203, US

(73) Assignee: UXB, Ashburn, VA (US)

(21) Appl. No.: 10/921,186

(22) Filed: Dec. 17, 2004

(51) Int. Cl. G21F 9/00

(52) U.S. Cl. 588/1

(57) ABSTRACT

A method of transporting known and unknown waste explosives or explosive materials from a site where they are located to a waste disposal facility. The waste explosives or explosive materials are placed in an explosion-proof vessel mounted on a mobile trailer or other vehicle at the site. Thereafter, the explosion-proof vessel and mobile vehicle are transported from the site to the waste disposal facility. The waste explosives or explosive materials do not have to be tested, identified or labeled before being transported.

### BACKGROUND AND SUMMARY OF THE INVENTION

The present invention relates to a new and improved method of transporting waste explosive materials and, more particularly, to such a method that enables a private party to transport known or unknown waste explosive materials to a waste disposal facility.

In many cases, when buried or abandoned munitions and explosives have been found on a site, along with explosive contaminated materials, they have been destroyed on the site by open burning or detonation. With increased environmental regulations and higher population densities around many sites, however, the practice of on-site disposal is not always safe for the public and/or acceptable for disposal.

As an alternative, in some limited cases, it is possible to transport in a special container a small amount of waste explosive material if it can be identified and is approved by government agencies such as the Department of Transportation (DOT). For transport, such materials must be packaged in special containers that are approved by DOT and each container must be labeled in accordance with DOT regulations. If a waste explosive material cannot be identified on the site where it is found, it cannot be transported to a waste disposal facility until it is tested and identified. Sometimes it is necessary to apply for exemptions from DOT or other governmental regulations before certain types of explosive materials can be transported. Such procedures are time-consuming and expensive. A need has arisen, therefore, for a new and improved method of transporting known and unknown waste explosive materials to a waste disposal facility.

### SUMMARY OF THE INVENTION

The method of the present invention meets the need for a new and improved method of transporting known and unknown waste explosive materials. In accordance with the method of the present invention, a predetermined amount of waste explosive materials are placed in an explosion-proof vessel mounted on a mobile trailer, other vehicle, or the like for one-way transport by a private vehicle to a waste disposal facility. The waste explosive materials do not have to be approved for shipment, specifically identified or labeled in accordance with DOT regulations. The new and improved method of the present invention has received an exemption from DOT.

### BRIEF DESCRIPTION OF THE DRAWINGS

FIG. 1 is a plan view of one embodiment of apparatus for use in the method of the present invention;

FIG. 2 is a side elevational view of the apparatus shown in FIG. 1; and

FIG. 3 is a rear elevational view of the apparatus shown in FIG. 1.

### DETAILED DESCRIPTION OF THE DRAWINGS

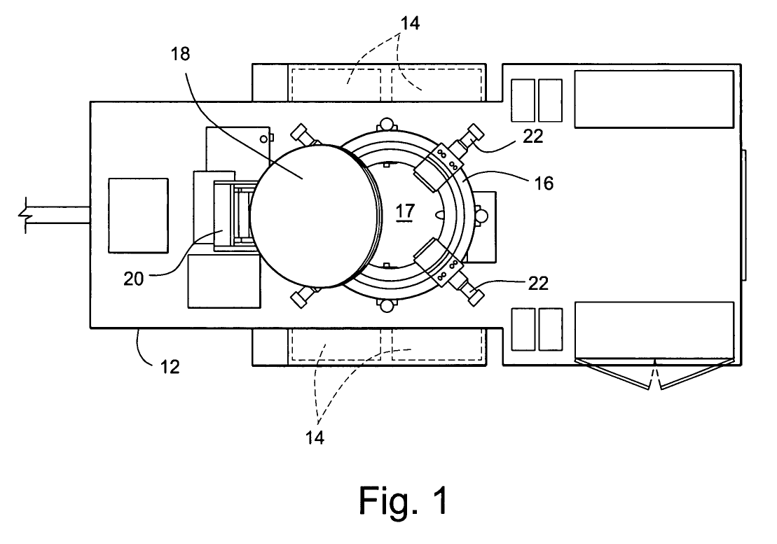

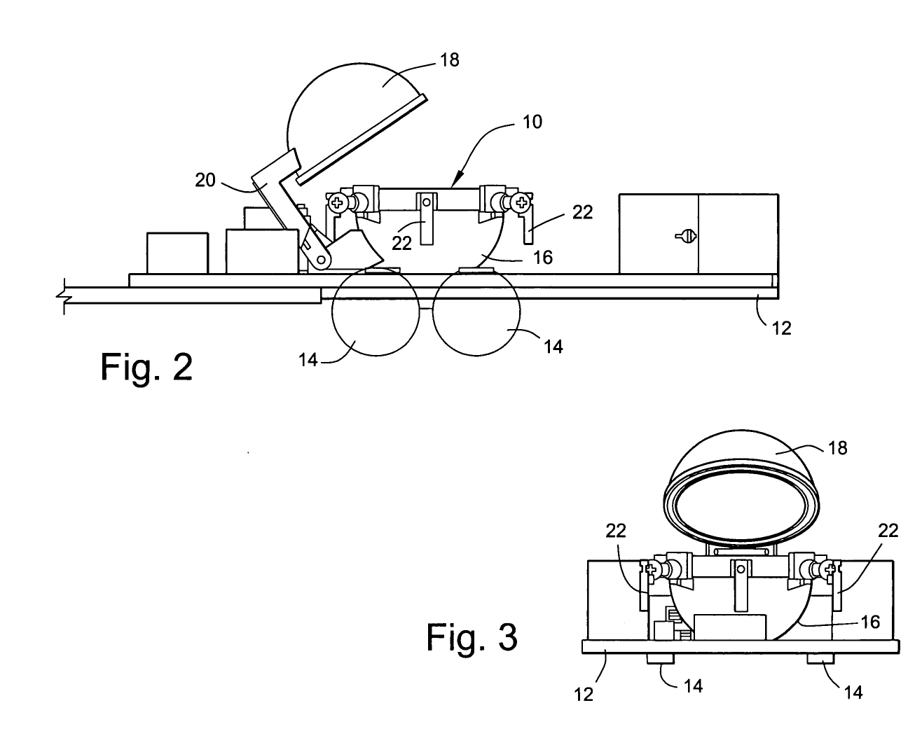

As shown in FIGS. 1-3, an explosion-proof vessel 10 is fixedly mounted on a trailer 12 or other vehicle of any suitable type having wheels 14. The vessel 10 comprises a base 16 and a cover 18 movable between the open position in FIGS. 1-3 and the closed position shown in broken lines in FIG. 2 wherein it closes the chamber 17 of the base 16. The cover 18 may be connected to an arm 20 that is pivotable with respect to the base 16. One or more locking devices 22 of any suitable construction or location may be used to retain the cover 18 in the closed portion on the base 16.

According to a method of the present invention, waste explosive materials are placed in the chamber 17 of the base 16 of the explosion-proof vessel 10 mounted on the mobile trailer 12, other vehicle or the like for one-way transport by a vehicle (not shown) to a waste disposal facility. In this manner, the waste explosive materials do not have to be specifically tested, identified or labeled in accordance with DOT or other government regulations. The explosion-proof vessel 10 may be of any suitable construction or material, such as the spherical vessel, shown in FIGS. 1-3 and should be constructed to withstand an explosive force that exceeds that of the total weight of waste explosive materials placed therein. Any suitable type of trailer, mobile support, or other vehicle, may be used to support the bomb-proof vessel 10. Also, any suitable type of vehicle such as a truck may be used to pull the trailer 12 with the explosion-proof vessel 10 mounted thereon.

The waste explosive materials may be placed in suitable containers (not shown) that are sift-proof or waterproof for certain environments with sufficient dunnage or cushioning of any suitable type to prevent movement within the container during transport. Also, the containers may be sufficiently cushioned, blocked or braced in any suitable manner within the chamber 17 of the base 16 of the explosion-proof vessel 10 to prevent movement thereof during transport. The containers may be formed, for example, of suitable plastic or fiberboard materials. It is preferable that the total amount of explosives, inert materials, packagings and dunnage not exceed approximately 60% of the volumetric capacity of the explosion-proof vessel.

The present method is useful for the transport of certain Class 1 solid waste explosive or hazardous materials. As an illustrative example, where the total mass of waste explosive materials in the chamber 17 will not exceed 4.5 kilograms (10 pounds), the explosion-proof vessel 10 should be constructed to withstand a repetitive explosive force or detonation of not less than 5 kilograms (11.2 pounds) of dry PETN. Repetitive detonation in this case means that the explosion-proof vessel 10 is constructed to totally contain (including blast effects, fragments, all gases and noise) a detonation of this magnitude without damage to the vessel so that it can be re-used.

It is anticipated that the present method would be used to transport explosives or explosive containing items or materials directly to a licensed, registered disposal facility and not to any other facility or intermediate point. The use of the method of this invention would enhance safety in transportation and protection of the public, especially in cases where the nature, history or exact nomenclature of the explosives or explosive materials may not be known.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of transporting known and unknown waste explosives or explosive materials from a site where they are located to a waste disposal facility, comprising:
placing the known and/or unknown waste explosives or explosive materials in a explosion-proof vessel fixedly mounted on a mobile trailer or other vehicle at the site; and
transporting the explosion-proof vessel and mobile trailer or vehicle from the site to the waste disposal facility.

2. The method of claim 1 wherein the explosion-proof vessel has a cover mounted thereon for movement between an open and a closed position.

3. The method of claim 2 wherein said explosion-proof vessel comprises a locking device for locking said cover in said closed position.

4. The method of claim 1 wherein the explosion-proof vessel is constructed to withstand a repetitive explosive force that exceeds that of the total weight of waste explosives or explosive materials placed therein.

5. The method of claim 1 wherein the waste explosives or explosive materials are placed in sift-proof or waterproof containers before being placed in the explosion-proof vessel.

6. The method of claim 5 wherein the waste explosives or explosive materials are cushioned within the containers to prevent significant movement therein.

7. The method of claim 6 wherein the containers are braced or blocked within the explosion-proof vessel to prevent significant movement of the containers therein.

8. The method of claim 1 wherein the total amount of waste explosives or explosive materials, containers, cushioning and braces or blocks does not exceed approximately 60% of the volumetric capacity of the explosion-proof vessel.

9. The method of claim 5 wherein the containers are formed of plastic or fiberboard materials.

10. The method of claim 1 wherein the waste explosives or explosive materials are Class 1 solid waste explosive or hazardous materials.

11. The method of claim 1 wherein the explosion-proof vessel is a spherical steel container.
